(19) United States
(12) Patent Application Publication
(10) Pub. No.: US 2006/0022090 A1
(43) Pub. Date: Feb. 2, 2006

(54) CARRY-ON LUGGAGE SYSTEM FOR AN OPERATIONAL GROUND SUPPORT SYSTEM

(75) Inventors: William R. McCoskey, Bothell, WA (US); Richard N. Johnson, Anacortes, WA (US)

Correspondence Address: ARTZ & ARTZ, P.C., 28333 TELEGRAPH RD., SUITE 250, SOUTHFIELD, MI, 48034, US

(73) Assignee: THE BOEING COMPANY `, Chicago, IL (US)

(21) Appl. No.: 11/163,405

(22) Filed: Oct. 18, 2005

Related U.S. Application Data
(63) Continuation-in-part of application No. 10/847,739, filed on May 17, 2004.

(51) Int. Cl. B64C 1/22

(52) U.S. Cl. 244/137.1

(57) ABSTRACT

A carry-on luggage system (450) for an airport includes a carry-on interface station (453). A carry-on transport module (452) is disposed and accessible within the carry-on interface station (453) and includes multiple stowage units (467) for carry-on items. A transport mechanism (451) transports the carry-on transport module (452) between the airport interface terminal (14) and an aircraft. A method of loading and unloading carry-on items on and off an aircraft includes providing access to a stowage unit (467). The stowage unit (467) is on a carry-on transport module (452) at a carry-on interface station (453). Access to the stowage unit (467) allows for placement of at least one carry-on item therein. The carry-on transport module (452) is transported between the carry-on interface station (453) and an aircraft.

### RELATED APPLICATION

The present application is a continuation-in-part (CIP) application of U.S. patent application entitled “Operational Ground Support System”, having U.S. Ser. No. 10/847,739, filed May 17, 2004, which is incorporated by reference herein.

### TECHNICAL FIELD

The present invention relates generally to aeronautical vehicle ground support systems and automated, controlled ground mobility. More particularly, the present invention relates to an integrated airport system for loading and unloading of carry-on baggage to and from an aircraft.

### BACKGROUND OF THE INVENTION

It is desirable within the airline industry to provide efficient aircraft servicing and ground mobility. Time involved in taxiing to and from gates and in performing various servicing tasks, is directly related to the amount of time an aircraft is able to spend in flight. The more an aircraft is in flight the higher the potential profits associated with that aircraft.

Servicing an aircraft includes cargo servicing and/or handling. Cargo servicing and handling includes the loading and unloading of luggage by an airlines on and off of an aircraft. Traditionally, the loading and unloading of cargo occurred on a lower deck through a cargo bay.

In addition to cargo servicing, the time associated with the enplaning and deplaning of passengers and carry-on items can also limit gate productivity. Due to the wait time associated with checking in and pick-up of luggage at check-in counters and terminal pickup areas many passengers choose to carry-on baggage to avoid waiting. As a result, there is an ever-increasing amount of carry-on items. In addition, overhead compartments of a passenger cabin have limited capacity. Thus, carry-on items are often stored underneath passenger seats or elsewhere in the passenger compartment. The above-stated prolongs the enplaning and deplaning processes and congests the passenger compartment of the aircraft.

Increasing the size of overhead stowage bins has been implemented and considered. However, passengers as a result tend to carry-on an increased amount of and larger baggage. Thus, more items are stowed in overhead bins. The increased size of the overhead bins requires increased structure for support and thus increased weight, which negatively affects aircraft performance. Furthermore, the increased overhead bin sizes limits interior cabin layout and design.

Moreover, the use of cargo handling vehicles can be time consuming due to the steps involved in servicing the aircraft and the aircraft servicing location availability. The servicing vehicles typically need to be loaded at a location that is a considerable distance from and driven over to an airline terminal of interest, mated to the aircraft, and unloaded to service the aircraft. Aircraft servicing location availability is limited since most vehicle servicing of the aircraft can only be performed from the starboard side of the aircraft to prevent interference with the passenger bridge on the port side of the aircraft. Mating of the servicing vehicles to the aircraft is also undesirable since an aircraft can potentially be damaged.

Also, current systems and methods used for ground support of commercial aircraft are security limited. It is difficult to provide and maintain adequate and appropriate security with regard to an aircraft, due to the number of different services accessing the aircraft at multiple locations along either side of the aircraft while at a terminal gate.

Additionally ground support services can also adversely affect passenger experience with flying, as a result of the somewhat chaotic fashion in which ground support services are currently provided.

It is therefore desirable to provide improved aircraft cargo, luggage, and baggage, handling system with increased servicing efficiency and aircraft security, which also provide an improved passenger flying experience. It is also desirable that the improved servicing systems address both current infrastructure incompatibility limitations related to the introduction of aircraft and other inefficiencies associated with current aircraft and systems.

### SUMMARY OF THE INVENTION

One embodiment of the present invention provides a carry-on luggage system for an airport that includes a carry-on interface station. A carry-on transport module is disposed and accessible within the carry-on interface station and includes multiple stowage units for carry-on items. A transport mechanism transports the carry-on transport module between the airport interface terminal and an aircraft.

Another embodiment of the present invention provides a method of loading and unloading carry-on items on and off an aircraft. The method includes providing access to a stowage unit. The stowage unit is on a carry-on transport module at a carry-on interface station. Access to the stowage unit allows for placement of at least one carry-on item therein. The carry-on transport module is transported between the carry-on interface station and an aircraft.

The embodiments of the present invention provide several advantages. One such advantage is the provision of a terminal carry-on system that allows for the pre-loading of carry-on articles into carry-on transport modules. The carry-on system provides increased efficiency in passenger ingress and egress, aids in minimizing any apprehensions that passengers may have in becoming separated from their articles, and minimizes competition between passengers in first accessing or utilizing a overhead compartment storage area or the like. The terminal carry-on system significantly increases ingress and egress speed by facilitating the stowage and retrieval of personnel articles within a terminal prior to and after embarkation. Passengers are able to ingress without carrying carry-ons to their respective seats without competition from co-passengers for overhead stowage. Upon arrival to a terminal, the passengers may egress from the aircraft and retrieve their personnel effects within the terminal.

The carry-on system provides an organized means of handling and stowing carry-on items on an aircraft. This system also reduces the amount of available overhead bin space and thus increases aircraft interior cabin design flexibility. The carry-on system also provides increased security for carry-on items through personnel stowage units.

Moreover, additional advantages provided by other embodiments of the present invention are the provisions of a passenger-cargo loader/unloader and a portable ground servicing unit. These state embodiments allow for servicing of an aircraft and transporting of carry-on transport modules from locations other than at airport interface terminals. These embodiments also account for airports where terminal availability is limited.

The present invention itself, together with further objects and attendant advantages, will be best understood by reference to the following detailed description, taken in conjunction with the accompanying drawing.

### BRIEF DESCRIPTION OF THE DRAWINGS

FIG. 1 is a top view of an integrated operational ground support system for an aircraft in accordance with an embodiment of the present invention.

FIG. 2 is a side view of the integrated operational ground support system incorporating the use of an airport interface terminal docking port illustrated with a cargo elevator in a down state and in accordance with an embodiment of the present invention.

FIG. 3 is a side view of the integrated operational ground support system incorporating the use of an airport interface terminal docking port illustrated with a cargo elevator in an up state and in accordance with an embodiment of the present invention.

FIG. 4 is a perspective view of an integrated operational ground support system for an aircraft illustrating cargo handling in accordance with an embodiment of the present invention.

FIG. 5 is a perspective view of a terminal carry-on luggage system in accordance with another embodiment of the present invention.

FIG. 6 is a perspective view of a terminal carry-on luggage system in accordance with another embodiment of the present invention.

FIG. 7 is an overhead perspective view of a portion of the terminal carry-on luggage system of FIG. 5.

FIG. 8 is a logic flow diagram illustrating a method of loading and unloading carry-on items on and off an aircraft in accordance with another embodiment of the present invention.

FIG. 9 is a front perspective view of a passenger compartment portion of a nose service opening of the aircraft in accordance with an embodiment of the present invention.

FIG. 10 is a perspective view of an integrated operational ground support system for an aircraft incorporating the use airport interface terminals for both a nose opening aircraft and a non-nose opening aircraft in accordance with an embodiment of the present invention.

FIG. 11A is a side view of an integrated operational ground support system incorporating the use of a passenger/cargo loader-unloader in accordance with another embodiment of the present invention.

FIG. 11B is a perspective view of the integrated operational ground support system of FIG. 11A.

FIG. 12 is a perspective view of an integrated operational ground support system incorporating the use of a portable ground servicing unit in accordance with another embodiment of the present invention.

FIG. 13 is a perspective view of a an integrated operational ground support system incorporating the use of passenger transport modules in accordance with still another embodiment of the present invention.

FIG. 14 is a perspective view of an integrated operational ground support system for an aircraft in accordance with another embodiment of the present invention.

FIG. 15 is a perspective view of an integrated operational ground support system for an aircraft in accordance with yet another embodiment of the present invention.

FIG. 16 is a perspective view of the ground support system of FIG. 15 illustrating servicing bridge pivot motion.

FIG. 17 is a perspective view of a linear drive cargo lift in accordance with yet another embodiment of the present invention.

### DETAILED DESCRIPTION

In each of the following Figures, the same reference numerals are used to refer to the same components. While the present invention is described primarily with respect to systems and methods of carry-on servicing of an aircraft, the present invention may be adapted for various applications and systems including: aeronautical systems, land-based vehicle systems, or other applications or systems known in the art that require similar servicing. The present invention may be applied to front loaded, side loaded, or rear loaded aircraft.

In the following description, various operating parameters and components are described for one constructed embodiment. These specific parameters and components are included as examples and are not meant to be limiting.

Also, in the following description the terms “service”, “services”, and “servicing” may include and/or refer to any aircraft services, such as passenger ingress/egress services, cargo ingress/egress services, aircraft primary services, aircraft secondary services, galley services, cabin cleaning services, lavatory services, or other services known in the art. Primary services may include fuel, power, water, waste, air conditioning, engine start air, brake cooling, and other primary services. Secondary services may include cabin cleaning services, galley services, trash services, and other secondary services.

In addition, the term “carry-on item” refers to any luggage, baggage, or other item in which a passenger may check-in, pick-up, carry on, or stow onboard an aircraft. A carry-on item is not limit to those items that are merely carried-on by the passenger onboard an aircraft.

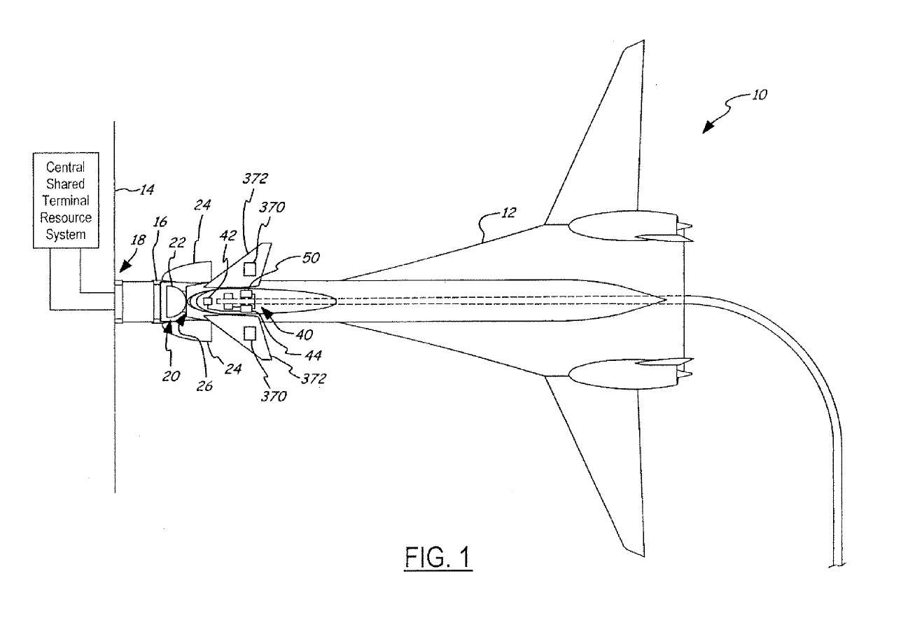

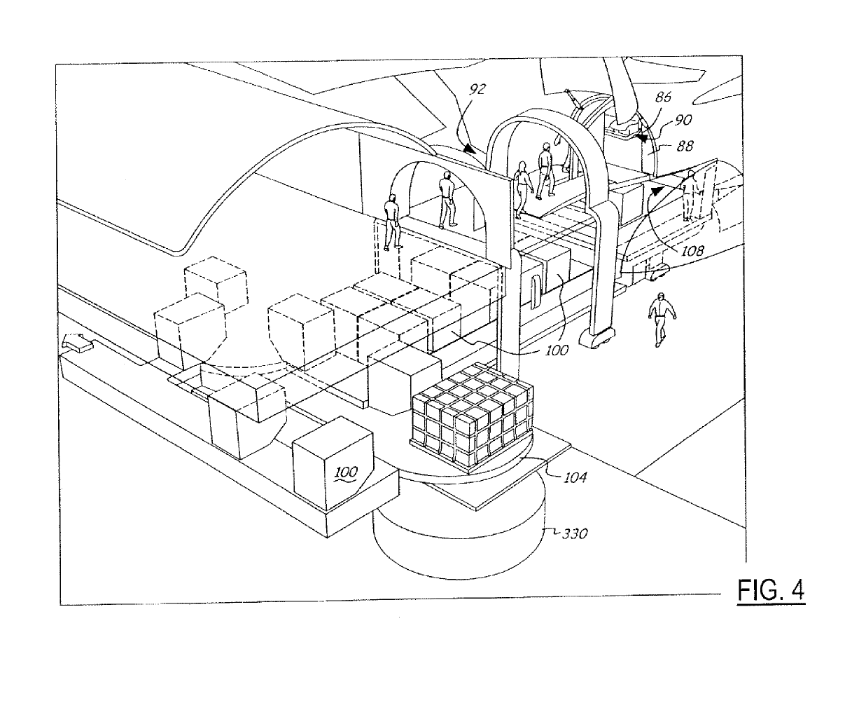

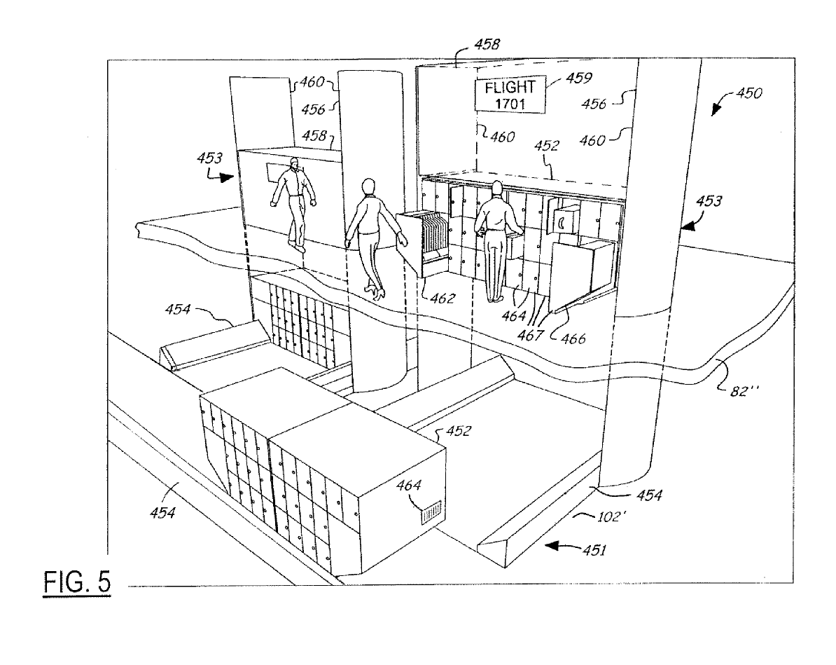

Referring now to FIG. 1, a top view of an integrated operational ground support system 10 for an aircraft 12 in accordance with an embodiment of the present invention is shown. Note that the aircraft shown in FIGS. 1-4 and 7-15 are for example purposes only, the present invention may be applied to various other aircraft known in the art. The integrated support system 10 includes the aircraft 12 and an airport interface terminal docking port 14 having a docking coupler or port 16. The aircraft 12 is shown at a particular gate 18 of the interface terminal 14. The aircraft 12 has a nose 20 that opens for the servicing of the aircraft 12 therethrough. The aircraft nose 20 may open in various manners. In the embodiment of FIG. 1, the nose 20 has an upper nose cap 22 and a pair of lower quarter covers 24, sometimes referred to as clamshell doors. The cap 22 and covers 24 are hinged to open in an upward direction and away from a service opening 26. Service opening 26 is one example of a service opening, other examples are provided below with respect to the other embodiments of the present invention. The interface terminal 14 services the aircraft 12 through the service opening 26. The interface terminal 14 provides such servicing through the use of various ground service support sub-systems, which are best seen in FIGS. 4-6. Other sample support sub-systems and integrated operational ground support systems are provided and described with respect to the embodiments of FIGS. 5-15.

The aircraft 12 may include an onboard aircraft terminal mating control system 40 for guidance of the aircraft 12 to and from the terminal 14. The onboard system 40 includes a global positioning system (GPS) or navigation system 42, which may be in communication with GPS satellites and a central tower (not shown) and is used by the controller 44 to guide the aircraft 12 upon landing on the ground to the terminal 14. This guidance may be referred to as vehicle free ramp operations. See patent application having U.S. Ser. No. 10/847,739 and entitled, “Operational Ground Support System” for further infrastructure and operations description.

The largest percentage of damage to an aircraft occurs while an aircraft is on the ground. The damage may occur when taxiing and colliding with other aircraft or ground equipment, or while parked at a terminal gate by support operations vehicles. The onboard system 40 guides the aircraft 12 by automated means and controls the speed and position of each individual aircraft while in motion. The onboard system 40 is tower controlled via automatic pilot and is employed for ground movement. By having aircraft at a particular airport under controlled motion, ground separation requirements can be reduced. A reduction in ground separation requirements increases airport capacity while reducing the risk of collision with other aircraft and objects.

Once the aircraft 12 is in close proximity with the terminal 14, a precision guidance system 50 is used in replacement of the navigation system 42. The precision guidance system 50 precisely guides the aircraft 12 to the docking port 16 using machine vision controlled pick and place robotics techniques known in the art. A near gate proximity guide-strips or guidelines may be provided a tarmac for rapid and precise guidance of the aircraft 12 to the docking port 16.

Once the aircraft 12 is staged to the terminal 14, a system based on machine vision technology orients the docking port 16 in vertical and horizontal directions. After alignment, the docking port 16 is extended and mated with the aircraft 12. Once the aircraft 12 is mated to the docking port 16 the clamshell doors 22 and 24 are opened and the aircraft 12 is serviced through the nose 20.

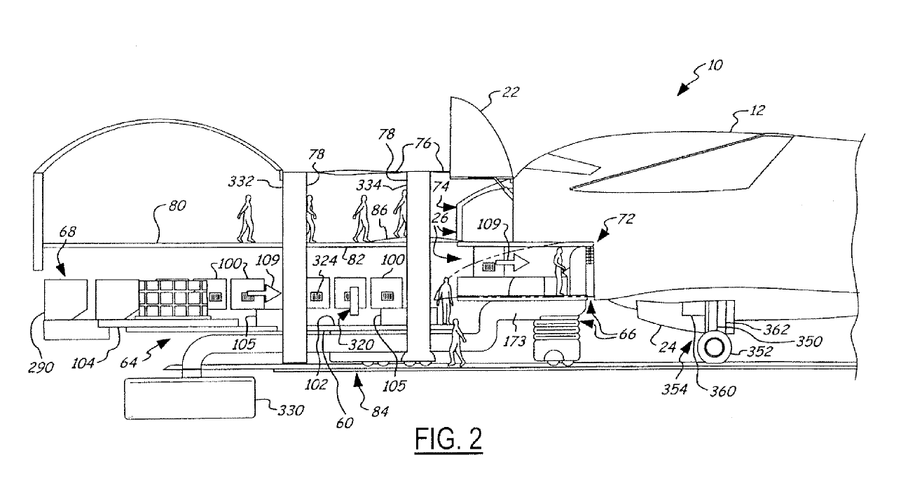

Referring now to FIGS. 2-4, side views of the integrated support system 10 are shown with a cargo elevator 60 in a “down” state and in an “up” state and a perspective view of the integrated support system 10 is shown illustrating cargo handling in accordance with an embodiment of the present invention. The integrated support system 10 includes various ground service support sub-systems, such as a passenger ingress/egress system 62, a cargo ingress/egress system 64, an aircraft primary service system 66, an aircraft secondary service system 68, a security system 70, and a health and maintenance monitoring system 72. Although only the service support sub-systems 62-72 are shown, other service-support sub-systems known in the art may be incorporated.

The passenger ingress/egress system 62 aids in the efficient ingress and egress of passengers to and from the aircraft 12. Passengers enter and exit to and from the interface terminal 14 through the terminal level portion 74 of the service opening 26. The interface terminal 14 has open glass ceilings 76 that are supported by columns 78. The passengers during the boarding process are guided through the terminal 14, on the terminal floor 80, to a terminal gate, such as gate 18. The passengers are then guided across an upper floor or terminal level 82 of the interface terminal 14 and over a coupler platform 86 to the aircraft 12.

The passengers, while being guided to and when arriving in the aircraft 12, experience the wide body interiors of both the aircraft 12 and the interface terminal 14. The passengers experience open, spacious, well lighted, and uncrowded views of the interface terminal 14 and the interior of the aircraft 12. This is best seen in FIGS. 4 and 7-8. The passengers may ingress and egress to and from the aircraft 12 in a twin column format, rather than through a narrow tunnel-loading ramp, as is the case with traditional systems. The integrated support system 10 thus provides a natural and inviting experience for the passengers.

Upon arrival of the aircraft 12, the nose 20 opens and the interface terminal 14 is mated with the service opening 26. The sidewalls and the ceiling panels within the wide body interior 86 of the aircraft 12 remain stationary. Partitions and/or doors 88 open between the passenger compartment 90 and the interface terminal 14. The passengers are presented with the interior 86 or the wide body interior 92 of the interface terminal 14 depending upon whether the passengers are entering or exiting the aircraft 12.

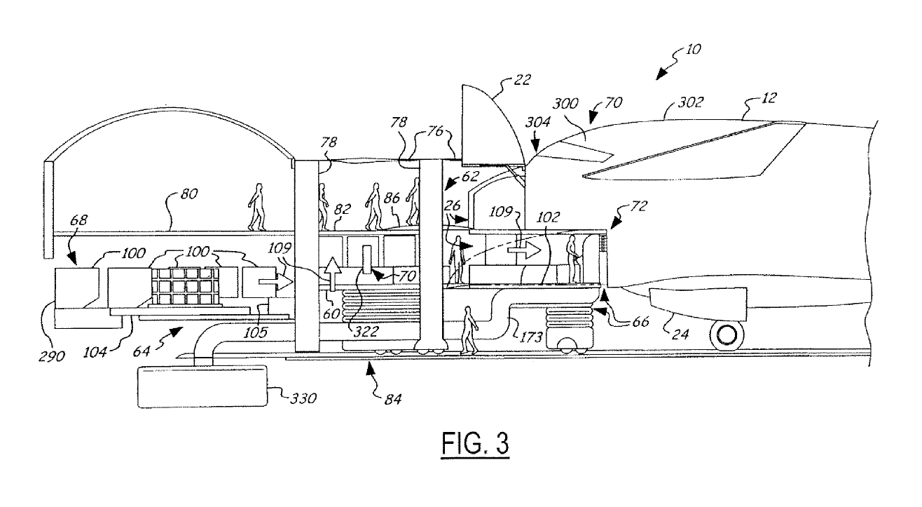

The cargo ingress/egress system 64 aids in the efficient loading and unloading of cargo, service carts, and other packages, containers, and baggages known in the art. When the aircraft 12 is at the gate 18, cargo that is loaded into the cargo containers 100 may be simultaneously loaded and unloaded at the tarmac level 102 of the interface terminal 14 while passengers are entering and exiting the aircraft 12 at the terminal level 82. The cargo containers 100 during the cargo loading process are transported to the terminal interface 14 and may be rotated on a cargo carousel 104 for proper orientation into the aircraft 12. The cargo containers 100 are then conveyed across the terminal interface 14 on conveyors 105 to the cargo elevator 60. The containers 100 are raised on the elevator 60 and are conveyed into the cargo area or lower hold 108 of the aircraft 12. This process is represented by arrows 109. The elevator 60 is shown in the down state in FIG. 2 and in the up state in FIG. 3.

The cargo containers 100 may be hitched together on both side tracks or rails like rail cars and conveyed over air bearings (not shown) to and from the aircraft 12. The containers 100 are conveyed longitudinally along the length of the aircraft 12 straight into and out of the lower hold 108. This eliminates the 900 shuffle of cargo containers from a cargo loader, along the side of and perpendicularly oriented with respect to an aircraft, to cargo areas fore and aft of the cargo loader, as normally experienced with traditional systems. The aircraft 12 may also have linear drives (not shown) to transport the containers and pallets on and off the aircraft 12. Locks and guides (not shown) may be located on the port and starboard sides of the cargo hold. Side locks enable automated insertion and removal of the containers and pallets without the need of human intervention to install and remove the forward and aft restraining dogs (not shown). The rails on the sides of the bottoms of the containers and pallets may be site modified to facilitate the automated side guide rail clamping, which reduces system complexity and increases robustness of the cargo system 64, while eliminating the need for manual intervention. Side guide rail clamping significantly reduces the costs exhibited by cargo handling and minimizes aircraft structural damage incurred from ground cargo activity experienced with prior cargo systems.

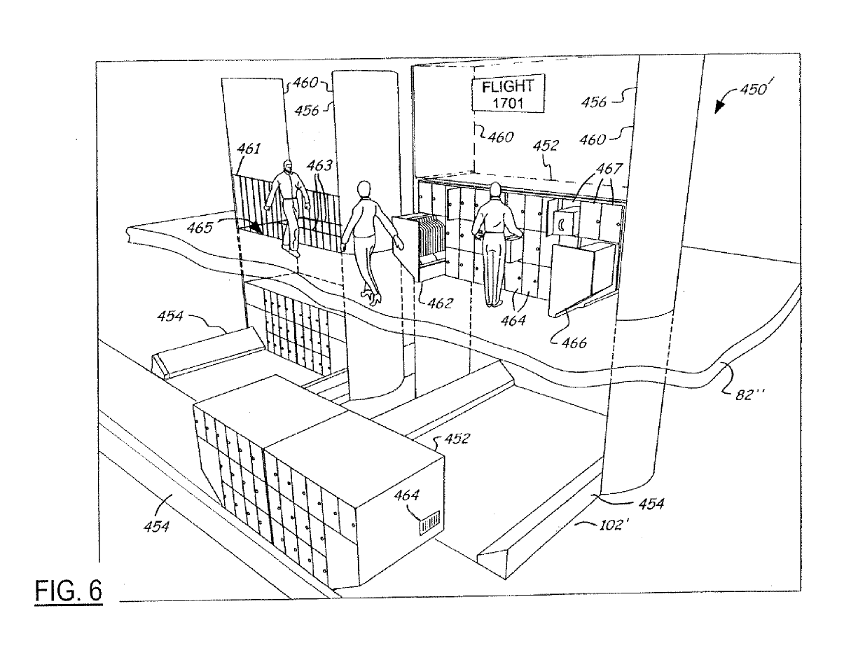

Referring now to FIGS. 5 and 6, perspective views terminal carry-on systems 450 and 450′ are shown in accordance with embodiments of the present invention. The terminal carry-on system 450 includes carry-on transport modules 452, which are loaded and unloaded within an interface terminal, such as in the previously identified interface terminal 14. The interface terminal may have multiple interface stations 453 associated with various flights, a couple examples of which are shown. The interface stations 453 may be in the form of carry-on loading or unloading stations.

The carry-on modules 452 may be conveyed via a carry-on transport system 451 having carry-on module conveyors 454, as shown, to, from, into, and out of an aircraft or through use of some other similar and appropriate transport mechanism, system, or device known in the art. The carry-on modules are conveyed to and from and on a different floor than the interface stations. The carry-on modules 452 may also be conveyed, similar to the cargo containers 100 above, into the lower hold and through a nose service opening of an aircraft, such as service opening 26.

The carry-on modules 452 are raised and lowered from the terminal level 82″ via elevators 456. The carry-on modules 452 may be raised or lowered from the interface stations 453 to be transported on a level above or below the terminal level 82′. The carry-on modules 452 are shown as being transported on a tarmac level 102′. The elevators 456 have elevator columns 460, which may include guides, chains, cables, electrical power supply devices, motors, communication devices, and other components, system, and/or devices that may be used to raise, lower, and supply power to operate and communicate with the elevators 456 and the carry-on modules 452.

The carry-on modules 452 may be replaced with false partitions 458 to prevent passengers from entering areas between elevator columns 460 when the carry-on modules 452 are in transit, as shown. In the example embodiment shown, as the carry-on modules 452 are removed from the interface stations 453 the false partitions 458 are lowered to be positioned in the interface stations 453 between the columns 460 and on the terminal level 82″. The false partitions 458 may include a flight designation panel 459, which may be electronically and remotely modified. The elevator columns 460 may have a logic circuit or switches (not shown) that activate movement of the false partitions 458 as the carry-on modules 452 are being removed from the interface stations 453 or the false partitions 458 may be moved using some other technique known in the art.

As an alternative to or in combination with the use of the false partitions 458, retractable and/or collapsible gates 461, retractable and/or folding platforms 463, or other devices known in the art may be used to prevent access to the interface stations 453 and/or elevator shaft areas 465, as shown in FIG. 6. Note that when the platforms 463 are used to cover the elevator shaft areas 465, the interface stations 463 may be utilized to allow pedestrian and/or vehicle traffic through and between the columns 460. Of course, and in addition to traffic utilization, the interface stations 463 when not being occupied by the carry-on modules 452 may be used for various other purposes.

The carry-on modules 452 have various stowage units 467 accessible on multiple sides thereof. The stowage units 467 may be of various size, shape, and style and may each be assigned to or accessible by one or more passengers, crewmembers, airport or airline personnel, and/or other authorized individuals. Overrides may be used to allow security personnel access to the stowage units 467. An override may be used, for example, when a passenger has lost their access pass, code, key, or other related item. The carry-on modules 452 may be designed to provide both cloak closets 462, carry-on cubbyhole lockers 464, as well as other carry-on containers or compartments known in the art, such as the compartment 466. The carry-on modules 462 may be loaded into a forward area of a cargo hold using a last on first off method.

The carry-on modules 452 may be tagged or have bar codes 464, as shown, or other identification elements which may be fixed, removable, interchangeable, or electronically altered. The bar codes 464 may be checked by a security system, such as the security system 70, while in transport to an aircraft. The bar codes 464 may also be read and used for transport identification information. The carry-on modules 452 may also be formed of an x-ray or scanning transparent material to allow for scanning of the carry-on items contained therein prior to boarding of an aircraft. The carry-on modules 452 are found of lightweight materials, such as aluminum, plastic, polyurethane, or other suitable materials to minimize weight thereof.

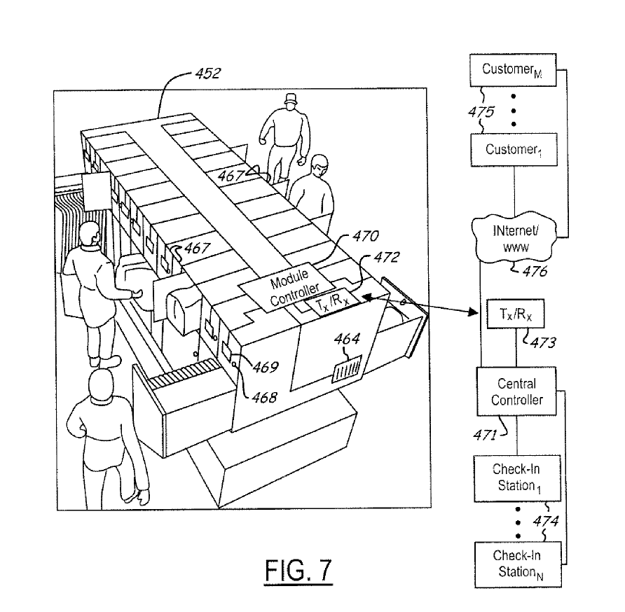

Referring now also to FIG. 7, a portion of the terminal carry-on system 450 is shown. The stowage units 467 may be assigned by airport personnel, airlines personnel, or through individual interaction therewith. For example, each stowage unit 467 may have a mechanical and/or electrical locking mechanism 468, which may be unlocked using a key, a code, or other mechanical or electronic access device. The stowage units 467 may have keys that are removable upon insertion of currency, such as change, or via a credit card reader. This is similar to that used on conventional lockers, in which monetary coins are inserted and the user then is able to remove a key that allows future access thereto. The stowage units 467 may in addition or alternatively have a barcode reader or scanner 469, as shown, or other electronic code entering device that allows access. In one embodiment of the present invention, the stowage units are accessible through swiping of a barcode located on a passenger ticket in front of one of the barcode readers 469 on the front of the stowage units 467. Interface station and associated identification addresses (not shown) may be used to aid in locating the assigned stowage units.

The carry-on modules 452 may have a module controller 470 that is coupled to each locking mechanism 468. The module controller 470 may receive transport signals, stowage unit signals, carry-on module signals, and other associated signals. The transport signals may command release of the carry-on modules 452 from the elevator columns 460 to allow for raising or lowering of the carry-on modules 452. The transport signals may command the locking of all stowage units 467, which may override authorized person access. The stowage units 467 may be locked when the carry-on modules 452 are not in their docked position at a terminal. This provides added security and prevents unwanted intrusion of passenger luggage by others.

The stowage unit signals may contain information to alter the assigned access codes for each of the stowage units 467 or other stowage unit related information. The carry-on module signals may contain information to alter the assigned identification codes or other related information pertaining to the carry-on modules.

The transport signals, the stowage unit signals, and the carry-on module signals may be transmitted and received wirelessly, as shown, or by wire to and from a central controller 471. A first transmitter/receiver 472 is coupled to the module controller 470 and a second transmitter/receiver 473 is coupled to the central controller 471. The central controller 470 may be an airport central operations controller, an airlines controller, an interface terminal controller, or some other controller known in the art. The central controller 470 is coupled to one or more check-in stations 474 that may be located anywhere in an airport. The check-in stations 474, for example, allow a passenger to check-in and obtain a flight ticket containing a barcode, which provides access to one or more of the stowage units 467. A passenger, at one of the customer sites 475, may receive a boarding pass having a stowage unit code via the Internet 476 remotely. The barcode received may allow access to a stowage unit on a certain date(s) and during a certain time range(s). For example, the barcode may have an associated usage date of Mar. 2, 2006 and time range for access of 2:00-5:00 p.m.

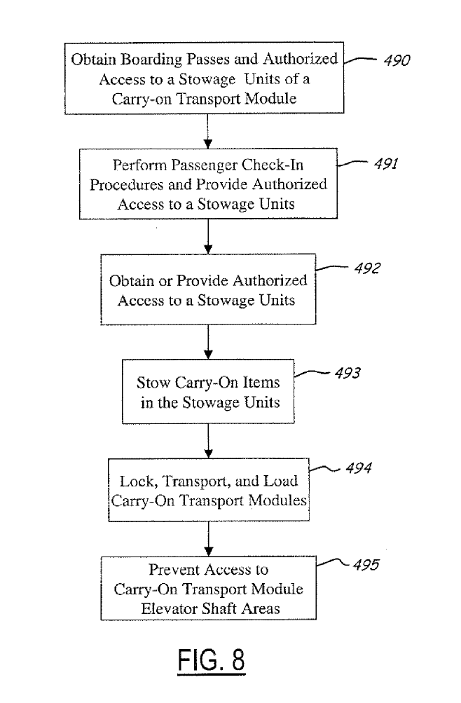

Referring now to FIG. 8, a method of loading and unloading carry-on items on and off an aircraft is shown in accordance with an embodiment of the present invention.

In step 490, passengers obtain their boarding passes. This may occur at a remote site or at an airport. The passengers may obtain authorized access, such as an access code or key, as described above for an assigned stowage bin upon obtaining the boarding pass.

In step 491, the passengers check-in at an airport. This may occur prior to an airline check-in counter, at a terminal gate, or elsewhere in the airport. The passengers may obtain authorized access as described above, when not previously provided, for an assigned stowage bin upon check-in. In step 492, as an alternative to steps 490 and 491, one or more passengers, crewmembers, airport or airline personnel, and/or other authorized person(s) may obtain access themselves or be provided access to one or more stowage units. The access may be obtained or provided upon arrival to the location of the appropriate carry-on transport module or elsewhere and at any time during the ticketing and boarding process. For example, a passenger may insert the proper funds into a receptor on one of the carry-on transport modules or elsewhere and obtain a key or authorized code to obtain access to a stowage unit.

In step 493, carry-on items are stowed in the stowage units. The passengers or other authorized person(s) arrive at the interface stations associated with their flight and access the assigned stowage units. The stowage units are accessed using the previously received access code or via some other technique; some techniques of which are described above. In one embodiment, after passengers have cleared security and have arrived at their gate of embarkation, they place cloaks and carry-on luggage into the carry-on modules 452 at the gate.

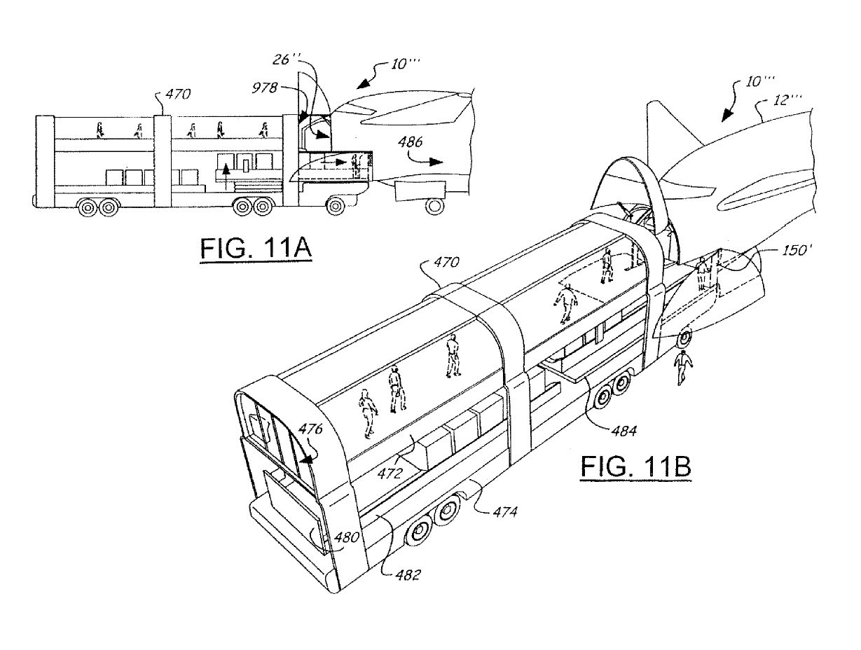

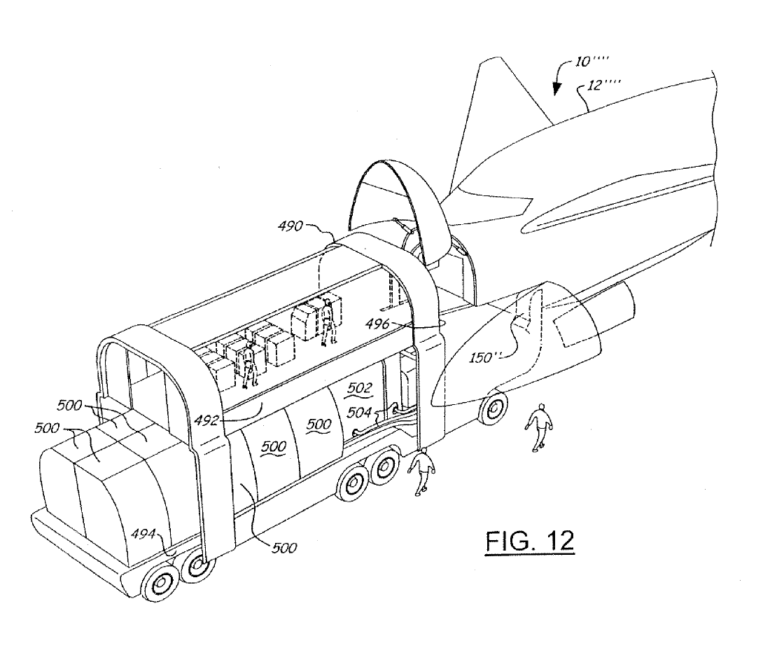

In step 494, at a predetermined time or upon command, the stowage units are locked and the carry-on modules for a particular flight are transported to and loaded onto the aircraft. This may occur upon filling of the carry-on modules. The carry-on modules are raised or lowered to a transport floor via the elevators and then transported to the appropriate interface terminal. The carry-on modules are boarded and removed from the aircraft in a first on last off fashion. The carry-on modules 452 are then lowered down to the tarmac level 102′ and directly conveyed into the appropriate aircraft. The carry-on modules may alternatively be transported to and onto the aircraft using aircraft passenger/cargo loader-unloaders or ground servicing units, such as that shown in FIGS. 11-12.

In step 495, access to elevator shaft areas are prevented via false partitions, gates, platforms, such as the false partitions, gate, and platforms, or via some other mechanisms known in the art. This provides safety and prevents passengers from walking between elevator columns when carry-on transport modules are not present in the elevator areas or interface stations. Access to the elevator areas may be prevented prior or subsequent to the lowering of the carry-on transport modules.

The above-stated method alleviates apprehensions passengers may have that are directed to becoming separated from their luggage, since they are able to load it themselves. In using the carry-on system 450, passengers need not compete with other fellow passengers for carry-on space within an aircraft. The carry-on system 450 also decreases boarding and disembarkment times. The above-stated method also free up the aircraft and gate for earlier cabin servicing and speeds up the entire turnaround process.

The above-stated steps 493-495 may be performed in a reverse order upon arrival at a destination. Upon arrival at the destination passengers retaining access to their respective assigned stowage units obtain access thereto and remove their carry-on items. The carry-on transport modules may be transported to a baggage pick-up area prior to being transported to a carry-on boarding or loading area for reuse. Access codes to the stowage units may be reset or changed after a predetermined time or, for example, upon transportation to the carry-on loading area. The above-described steps are also meant to be illustrative examples; the steps may be performed sequentially, synchronously, simultaneously, or in a different order depending upon the application.

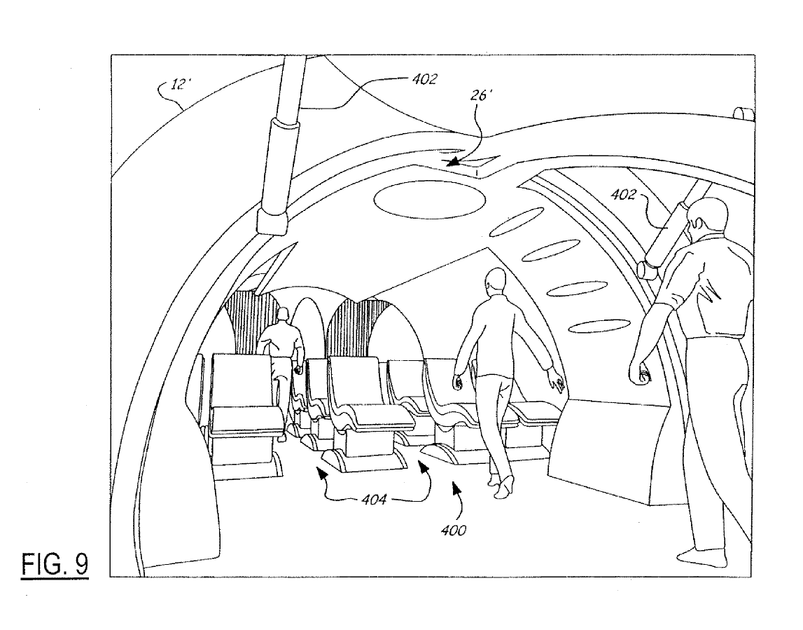

Referring now to FIG. 9, a front perspective view of a passenger compartment or cabin portion 400 of a nose service opening 26′ of an aircraft 12′ in accordance with an embodiment of the present invention is shown. The wide-open interior of the passenger cabin 400 can be viewed from the service opening 26′. A pair of hydraulic lifts 402 is shown for the opening of the upper cap (not shown, but similar to upper cap 22). Passengers may enter the aircraft 12′ and proceed in columns down aisles 404. Although an aircraft is shown having a twin aisle configuration, a similar configuration may be utilized for a single aisle aircraft.

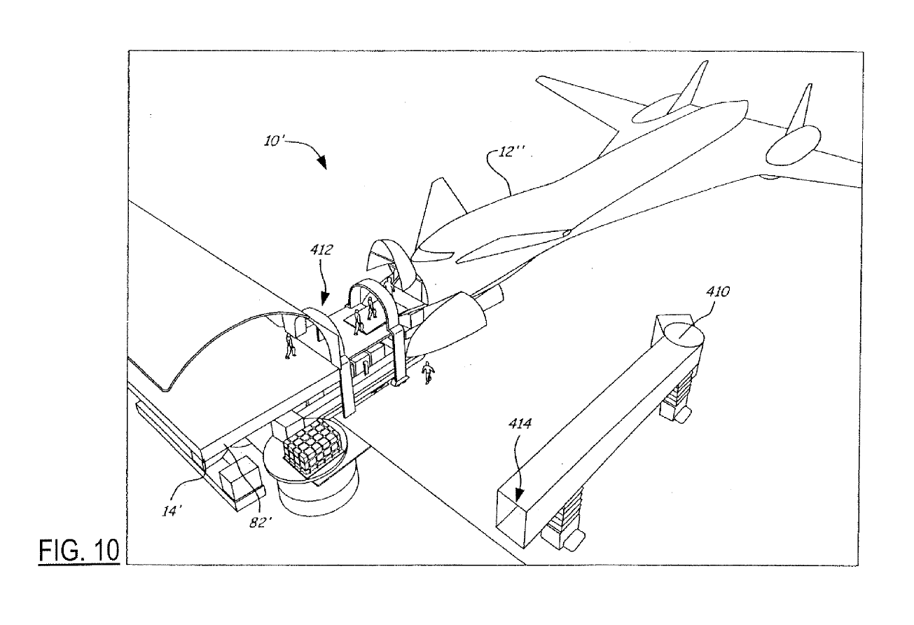

Referring now to FIG. 10, a perspective view of an integrated operational ground support system 10′ for an aircraft 12″ is shown that incorporates the use of an airport interface terminal 14′ that provides for servicing of both nose opening aircraft, such as aircraft 12″, and non-nose opening aircraft (not shown) in accordance with an embodiment of the present invention. The integrated support system 10′ includes the interface terminal 14′ that is similar to the interface terminal 14, but further includes a traditional style jetway 410. The interface terminal 14′ has a first gate 412 associated with the aircraft 12″ and a second gate 414 that is associated with the jetway 410. Passengers may ingress and egress from nose opening aircraft and non-nose opening aircraft over the terminal level 82′ of the interface terminal 14′.

Referring now to FIGS. 11A and 11B, a side view and a perspective view of an integrated operational ground support system 10″′ incorporating the use of an aircraft passenger/cargo loader-unloader 470 in accordance with another embodiment of the present invention is shown. The passenger/cargo loader-unloader 470 is mobile and may be used in replacement of an interface terminal. The passenger/cargo loader-unloader 470 also includes a terminal level 472 and a tarmac level 474. The terminal level 472 is used as a passenger servicing floor and the tarmac level 474 is used as a cargo transport floor. Passengers may enter the passenger/cargo loader-unloader 470 in the rear 476 at a terminal gate and exit in the front 478 through the service opening 26″ of the aircraft 12″′. Cargo may enter in the rear 476 over a cargo gate/ramp 480 onto a cargo platform 482 and conveyed across the cargo platform 482 onto a hydraulic lift platform 484, which raises the cargo to the cargo hold level 486 of the aircraft 12″′, via a main station 150′. Once raised the cargo may then be conveyed into the aircraft 12″′.

The passenger/cargo loader-unloader 470 is useful when it is necessary to load and unload passengers and cargo from an aircraft on a tarmac due to capacity limitations at terminals within an airport. The passenger/cargo loader-unloader 470 also allows for simultaneous ingress and egress of passengers and cargo from the aircraft 12″′, similar to that of the interface terminals 14 and 14′.

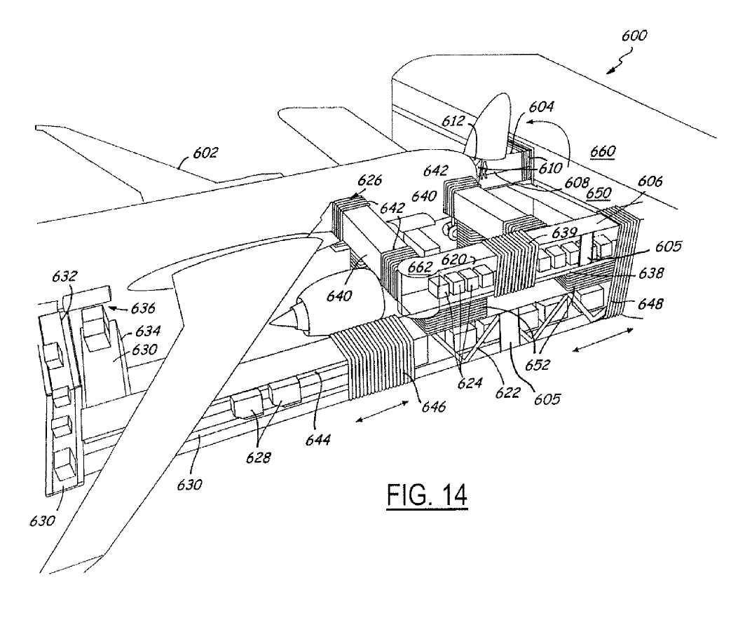

Although the loader/unloader 470 is shown as being utilized in conjunction with and mating to a nose of an aircraft, the loader/unloader 470 may be easily modified to mate to port or starboard sides of an aircraft. For example, the loader/unloader 470 may be used to service the aircrafts illustrated in FIGS. 14-16. The loader/unloader 470 may mate with service openings in the lower lobe regions forward of the wings on the port and starboard sides of the aircraft.

Referring now to FIG. 12, a perspective view of an integrated operational ground support system 10″″ incorporating the use of a portable ground-servicing unit 490 in accordance with another embodiment of the present invention is shown. The ground-servicing unit 490 may also be considered as an aircraft loader/unloader. The ground-servicing unit 490 is also mobile and may be used in replacement of an interface terminal. The ground-servicing unit 490 also includes a terminal level 492 and a tarmac level 494. The terminal 492 is used as a primary service floor and the tarmac level 494 is used as a secondary service floor. Secondary aircraft services may be provided on the terminal level 492. For example, galley carts, lavatory carts, trash carts, and other service carts may be conveyed onto the terminal level 492 from the rear and conveyed into the aircraft 12″″ through the front 496 of the ground servicing unit 490. The lower portion 498 of the ground-servicing unit 490 is similar to that of an interface terminal, such as the interface terminals 14 and 14′, in that it includes a main station 150″ that couples to the aircraft 12″″.

Various tanks and supply holding units 500 reside on the tarmac level 494 of the ground-servicing unit 490. The tanks and holding units 500 may be separate containers or may be part of a single segregated unit, as shown. The tanks and holding units 500 may be used to supply and extract materials, such as fuel, water, air, and coolant, as well as power to and from the aircraft 12″″. The tanks and holding units 500 may include a fuel tank, a potable water tank, a gray water tank, a brown water tank, an air start tank, an air-conditioning tank, an electrical supply holding unit, as well as other tanks and holding units known in the art. The materials may be supplied to and pumped from the aircraft 12″″ using pumps (not shown) within a pump housing 502 over lines 504. The pump housing 502 may contain pumps similar to pumps 202-214 above.

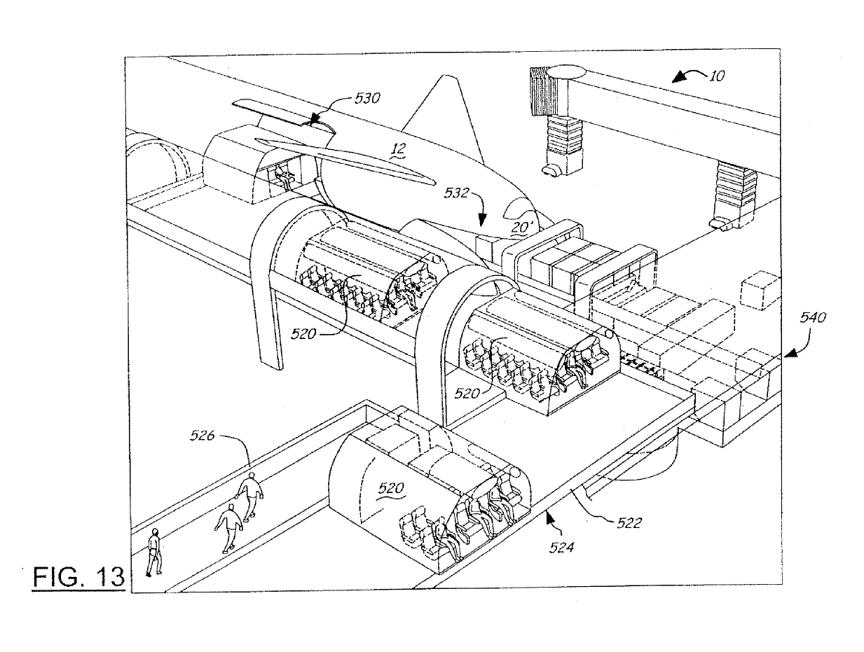

Referring now to FIG. 13, a perspective view of a an integrated operational ground support system 10^{V} incorporating the use of passenger transport modules 520 in accordance with still another embodiment of the present invention is shown. The integrated support system 10^{V} includes an interface terminal 522 configured to shuttle the passenger modules 520 to and from an aircraft 12^{V}. The passenger modules 520 are shuttled over a railway type system 524 to the aircraft 12^{V}. Passengers may pre-board the passenger modules 520 into their respective assigned seats at a gate 526 and then be shuttled into the aircraft 12^{V}. The assigned seats within the passenger modules 520 are the same assigned seats used on the aircraft 12^{V}. Once the modules 520 are positioned within the aircraft 12^{V} they are locked into place. This increases efficiency in the loading of passengers and carry-ons into segmented portions of an aircraft.

The passenger modules 520 are similar in shape and have a similar interior as that of an aircraft. The passenger modules 520 may include over head compartments, comfort and convenience features, such as air-conditioning controls, crewmember call buttons, head set jacks, lavatories, and other comfort and convenience features known in the art. Although the passenger modules 520 are shown as being loading into a side 530 of the aircraft 12^{V}, they may be loaded into the front 532 of the aircraft 12^{V} through a service opening, such as opening 26.

The interface terminal 522 also includes the cargo-loading portion of the integrated support system (of FIGS. 2-4), represented by numerical designator 540. Cargo is simultaneously loaded through the nose 20′ of the aircraft 12^{V}. Once the passenger modules 520 and cargo are loaded the nose 20′ closes and the aircraft 12^{V} departs from the interface terminal 522. The process is reversed when the aircraft 12^{V} arrives at its destination.

The above-described aircraft is also easily converted from a passenger aircraft to a freighter aircraft. Traditional aircraft are configured such that the interior passenger payloads, seats, lavatories, galleys, stow bins, etc., must be broken down into pieces and removed through the passenger entry door in order to convert from a passenger aircraft to a freighter aircraft. With a front loader configuration or an aircraft that allows loading and unloading through the nose, the passenger payloads can be installed as pre-built modules during assembly of the aircraft and later removed for rapid freighter conversion straight through the nose of the aircraft. System connections may be designed for quick connect and release. Cargo floors and liners may be designed for rapid installation and removal. This also facilitates rapid refurbishment when desired and rapid livery changes when ownership of the aircraft is changed.

Nearly all passenger airliners are converted into freight airlines. Through the nose servicing increases value of the aircraft for after market use by significantly lowering the cost of conversion. Reduced cost of conversion reduces the cost of ownership by raising the residual value of the aircraft.

Referring now to FIG. 14, a perspective view of an integrated operational ground support system 600 for an aircraft 602 in accordance with another embodiment of the present invention is shown. The ground support system 600 includes a passenger servicing bridge 604 and a multi-level cabin and cargo servicing bridge 606 that is separate and isolated from the passenger servicing bridge 604. The servicing bridges 604 and 606 may have any number of auxiliary access doors 605.

The passenger servicing bridge 604 includes a passenger main bridge section 608 and one or more flex extensions 610. Passengers ingress and egress from the aircraft 602 within the passenger main section 608 through the nose 612 of the aircraft 602.

The cabin and cargo servicing bridge 606 includes an upper level or terminal level 620 and a lower level or cargo level 622. Ingress and egress of service carts 624 and cabin cleaning crewmembers is performed on the terminal level 620 through the upper service openings 626 of the aircraft 602. Ingress and egress of cargo 628 is performed on the cargo level 622. The cargo 628 is loaded in and unloaded from the aircraft 602 via conveyors 630, including a ramp conveyor 632 and a linear drive cargo lift 634 through the lower service opening 636.

The terminal level 620 includes a cabin main bridge section 638 with a flex extension 639 and a pair of lateral bridge sections 640, each of which having flex extensions 642. The cargo level 622 includes a cargo main bridge section 644 also with a flex extension 646. Another flex extension 648 may also be utilized between a multi level rotunda 650 and the cabin and cargo servicing bridge 606. The terminal level 620 is coupled to the cargo level 622 via bridge lifts 652 for adjusting vertical position of the terminal level 620.

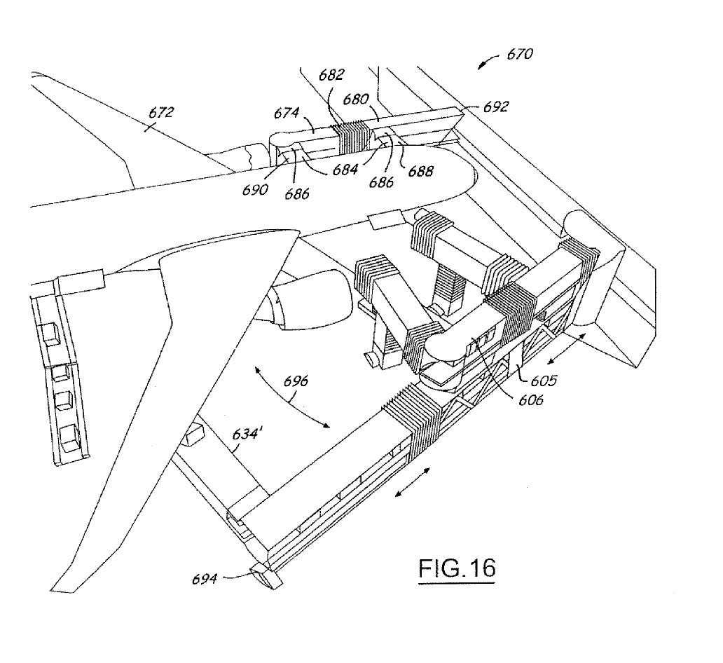

Various rotundas may exist between the terminal 660 and the bridges 604 and 606 and as part of the bridges 604 and 606, such as the rotunda 662, to allow the bridges 604 and 606 to rotate to and away from the aircraft 602. Motion of the flex extensions 642 and the rotundas 650 and 662 is illustrated in FIG. 16.

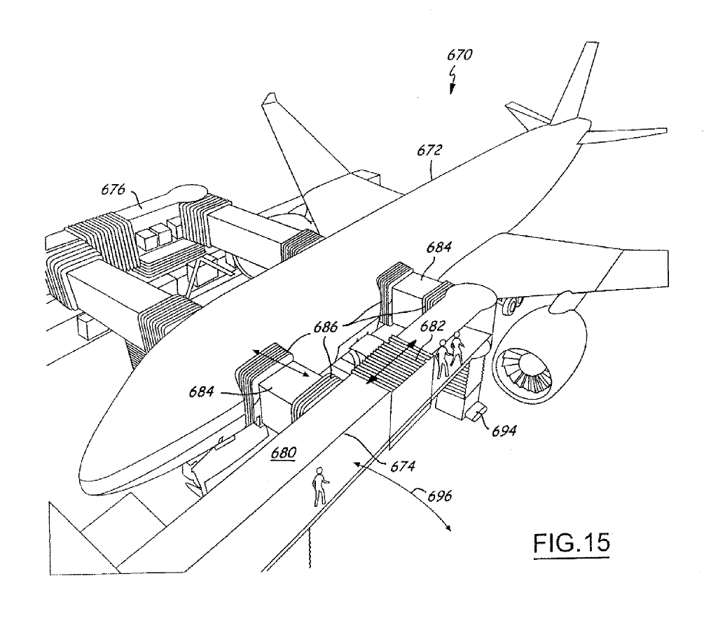

Referring now to FIGS. 15 and 16, a perspective view of an integrated operational ground support system 670 for an aircraft 672 and a perspective view illustrating servicing bridge pivot motion thereof are shown in accordance with yet another embodiment of the present invention. The ground support system 670 includes a passenger servicing bridge 674 and a cabin and cargo servicing bridge 606′, which is similar to the cabin and cargo servicing bridge 606. The passenger servicing bridge 674 couples to the port side of the aircraft 672 to allow passenger ingress and egress therethrough.

The passenger servicing bridge 674 includes a passenger main bridge section 680 with a flex extension 682 and a pair of bridgeheads 684, each with a pair of flex extensions 686. Passengers may ingress and egress within and along the main section 680 into a port side of the aircraft 672 via the bridgeheads 684. The bridgeheads 684 include a first fore bridgehead 688 and a first aft bridgehead 690. Flex extensions 682 and 692 allow the bridgeheads 684 to be articulated in fore and aft directions along the aircraft 672 for proper alignment with aircraft doors.

The passenger servicing bridge 674 and the cabin and cargo servicing bridge 606′ may be on wheels 694 and rotated to and away from the aircraft 672, as is depicted by arrows 696. The linear drive cargo lift 634′ may be coupled to the cabin and cargo servicing bridge 606′ and be rotated away from the aircraft 672 simultaneously with the cabin and cargo servicing bridge 606′.

With conventional aircraft, services may be supplied with service docking couplers that engage with the aircraft from the lower lobe regions on the port and starboard sides forward of the wings. Cargo loading and unloading may also be automated.

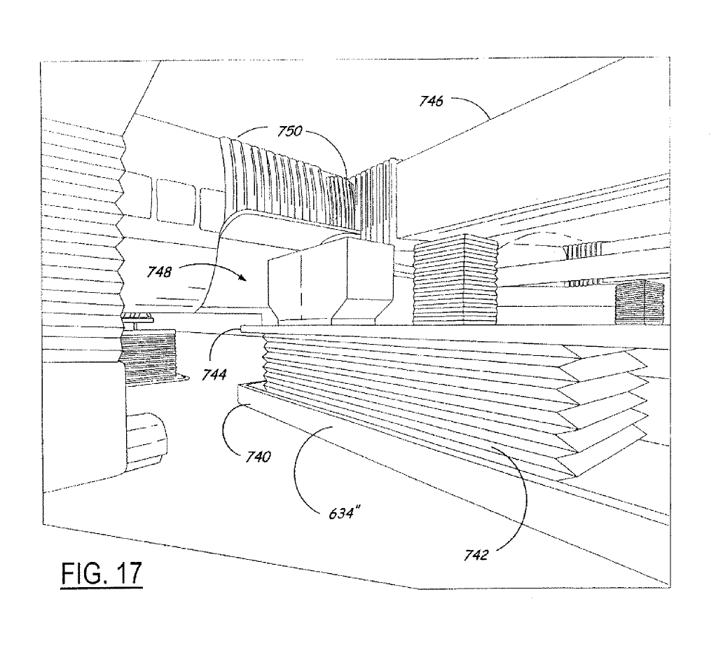

Referring now to FIG. 17, a perspective view of a linear drive cargo lift 634″ in accordance with yet another embodiment of the present invention is shown. The linear drive cargo lift 634″ includes a base 740 with a flex extension 742 oriented to provide lift to a conveyor table 744. Objects are transported on the conveyor table 744 from the cabin and cargo servicing bridge 746 to the cargo hold 748 of the aircraft 750.

The present invention provides passengers with an efficient technique for securing and stowing carry-on items prior to aircraft arrival. The technique also allows for quick retrieval of the carry-ons after disembarking from the aircraft to a terminal gate. The present invention provides carry-on modules that are accessible prior to entering an aircraft and upon exiting an aircraft. The technique of the present invention also provides a new revenue stream for airlines. The above technique may be provided as an additional service, which may be billed to aircraft passengers who elect such service. Those who do not elect such service would check-in baggage and carry on items using traditional methods.

The present invention reduces the volume of items carried on and yet allows for essential items, such as laptop computers, briefcases, chilled care bags, and other essential items to be carried on an aircraft. The present invention reduces the number of non-in-flight required baggage carried on an aircraft. The present invention provides a modular carry-on system that may be applied to various airport architectures.

The present invention provides integrates ground support systems that provide shortened gate turn around times and are convenient and efficient for both the airlines and flying public. The nose servicing aspects of the present invention allow for increased space capacity within an aircraft for an increased number of seats and cargo space. The nose servicing aspects also eliminate the need for side passenger ingress and egress doors and side cargo ingress and egress doors. Side passenger doors may be replaced with escape hatches. The reduced number of side doors also minimizes aircraft corrosion from water intrusion in doorways. The nose servicing aspects also minimize aircraft cargo handling systems.

The architecture of the integrated system provides shortened gate turn around cycles, reduced ground support personnel, reduced ground support equipment, and reduced risk of damage to an aircraft through ground support activities.

Through use of the present invention, the ground support working environment is significantly improved. Ground support personnel are able to service an aircraft within an enclosed environmentally controlled working environment with minimal fumes. Safety is improved and traditional sources of long-term physical aircraft damage are minimized. The ground support personnel are segregated from tarmac noise and environmental elements.

The present invention also improves airport runway capacity and airport throughput. The present invention also minimizes ground support equipment needed for servicing of an aircraft.

The above-described apparatus and method, to one skilled in the art, is capable of being adapted for various applications and systems including: aeronautical systems, land-based vehicle systems, or other applications or systems known in the art that require servicing of a vehicle. The above-described invention can also be varied without deviating from the true scope of the invention.

What is claimed is:

1. A carry-on luggage system for an airport comprising:
a carry-on interface station;
at least one carry-on transport module disposed and accessible within said carry-on interface station and comprising a plurality of stowage units for carry-on items; and
a transport mechanism transporting said at least one carry-on transport module between said carry-on interface terminal and an aircraft.

2. A system as in claim 1 wherein said airport interface terminal comprises an elevator, said elevator raising and lowering said at least one carry-on transport module between floors of the airport.

3. A system as in claim 2 further comprising a blocking device preventing access to an elevator shaft area of said elevator.

4. A system as in claim 3 wherein said blocking device is selected from at least one of a false partition, a gate, and a platform.

5. A system as in claim 3 wherein said elevator shaft blocking device is systematically deployed and stowed in response to arrival and departure of said at least one carry-on transport module to and from said airport interface terminal.

6. A system as in claim 1 wherein said plurality of stowage units comprises at least one locking mechanism.

7. A system as in claim 6 wherein said at least one locking mechanism comprises a keyed lock.

8. A system as in claim 6 wherein said at least one locking mechanism is coupled to a bar code reader.

9. A system as in claim 6 wherein said at least one locking mechanism is unlocked through input of a code.

10. A system as in claim 1 wherein said at least one carry-on transport module is bar-coded.

11. A system as in claim 1 wherein said stowage units are accessible from at least one individual in at least one group selected from passengers, crewmembers, and airport personnel.

12. A system as in claim 1 further comprising a controller coupled and controlling access to said plurality of stowage units.

13. A system as in claim 12 further comprising at least one check-in station coupled to said controller and generating passenger signals, said controller controlling said access in response to said passenger signals.

14. A system as in claim 1 wherein said at least one carry-on transport module comprises a plurality of accessible sides.

15. An integrated operational ground mobility and support system comprising:
at least one aircraft having at least one service opening; and
at least one airport interface terminal docking port having at least one ground support service sub-system, mating with said at least one aircraft at said at least one service opening, and comprising a plurality of servicing levels;
said at least one ground support service sub-system providing carry-on servicing through said at least one service opening utilizing at least one carry-on transport module.

16. A ground support system as in claim 15 wherein said at least one service opening comprises an aircraft nose that at least partially opens to allow servicing of said at least one aircraft therethrough.

17. A ground support system as in claim 15 wherein said nose opens to a passenger compartment.

18. A ground support system as in claim 15 wherein said at least one airport docking port comprises a carry-on transport module elevator platform.

19. A ground support system as in claim 15 further comprising a terminal carry-on system comprising:
a carry-on interface station;
at least one carry-on transport module disposed and accessible within said carry-on interface station and comprising a plurality of stowage units for carry-on items; and
a transport mechanism transporting said at least one carry-on transport module between said airport interface terminal and an aircraft.

20. A ground support system as in claim 19 wherein said at least one airport interface terminal docking port shuttles said at least one carry-on transport module to and from said at least one aircraft.

21. A method of loading and unloading carry-on items on and off an aircraft comprising:
providing access to a stowage unit on a carry-on transport module at a carry-on interface station for placement of at least one carry-on item in said stowage unit; and
transporting said carry-on transport module between said carry-on interface station and an aircraft.

22. A method as in claim 21 further comprising preventing access to an elevator shaft area of said carry-on interface station when said carry-on transport module is not present in said carry-on interface station.

23. A method as in claim 21 further comprising locking said stowage unit.

24. A method as in claim 21 further comprising:
tagging said carry-on interface module;
reading said tag and generating a transport signal; and
transporting said carry-on transport module to an appropriate carry-on interface station in response to said transport signal.

25. A method as in claim 21 further comprising:
receiving a code; and
providing said access in response to said code.
